(19) United States
(12) Patent Application Publication
(10) Pub. No.: US 2002/0184761 A1
(43) Pub. Date: Dec. 12, 2002

(54) INK JET PRINTER HEAD AND MANUFACTURING METHOD THEREOF

(76) Inventors: TAKAO NISHIKAWA, NAGANO-KEN (JP); ATSUSHI TAKAKUWA, NAGANO-KEN (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 09/202,267

(22) PCT Filed: Apr. 10, 1998
(86) PCT No.: PCT/JP98/01678

(30) Foreign Application Priority Data
Apr. 15, 1997 (JP) 9-97780

(51) Int. Cl. B23P 17/00; H04R 17/00; B41J 2/045

(52) U.S. Cl. 29/890.1; 29/25.35; 347/68

(57) ABSTRACT

With a view to permitting manufacture of an ink jet head capable of coping with a higher resolution at a low cost through a simple process, the method of manufacturing an ink jet printer head of the invention comprises the step of ejecting an ink by pressurizing an ink pressure chamber by means of a piezo-electric element deforming in response to an electric signal, provided on a head base forming the ink pressure chamber; wherein a manufacturing method of the head base comprises a first step of manufacturing a green sheet having a prescribed relief pattern in response to the head base; a second step of forming the head base by coating and solidifying a material for forming the head base on the surface of the green sheet having the relief pattern; a third step of stripping off the head base from the green sheet; and a fourth step of forming a nozzle port for discharging the ink on the head base.

### TECHNICAL FIELD

The present invention relates to an ink jet printer head using a piezo-electric element as a driving source for ejecting an ink and a manufacturing method thereof.

### BACKGROUND ART

There is available a piezo-electric type ink jet printer head using a piezo-electric element comprising a PZT as an electromechanical conversion element which is a driving source for ejecting a liquid or an ink.

FIG. 11 illustrates the structure of a typical ink jet printer head of this type: 12 is a head base; 29 is a common electrode (vibrating plate); 32 is a piezo-electric element; 33 is a ink pressure chamber; 35 is a nozzle plate having an ink discharging nozzle port 13; 36 is an ink inlet; 37 is a reservoir; 38 is an ink tank port; and other component elements include a wiring pattern, a signal circuit, an ink tank and the like not shown.

Such an ink jet printer head is manufactured by a process achieved by the application in general of the lithographic technology. FIG. 12 schematically illustrates an example of the manufacturing process in the form of a sectional view of FIG. 11 cut along the line A-A′.

As shown in FIG. 12(a), the common electrode 29, a piezo-electric thin film 30 and an upper electrode 31 are sequentially formed on a silicon substrate (wafer) 39.

Then, as shown in FIG. 12(b), a resist layer 15 is formed on the upper electrode 31, exposed and developed into a prescribed pattern through a mask to pattern the resist layer.

As shown in FIG. 12(c), the piezo-electric thin film 30 and the upper electrode 31 are etched with the resist layer 15 as a mask. Then, the resist layer 15 is stripped off, thereby obtaining the piezo-electric element 32.

Then, as shown in FIG. 12(d), a resist layer 15 is formed on the surface opposite to the side on which the piezo-electric element 32 has been formed, exposed and developed into a prescribed pattern through a mask to pattern the resist layer 15.

With this resist layer 15 as a mask, an oxide film 40 and the silicon wafer 39 are etched, and the resist layer 15 is stripped off, thus obtaining the head base 12 having the ink pressure chamber 33 formed thereon.

The nozzle plate 35 having an ink discharging nozzle port 13 formed at a position corresponding to the ink pressure chamber 33 is connected (adheres) to the thus manufactured head base 12 via an adhering layer or the like as shown in FIG. 12(f). Further, a wiring pattern, a signal circuit, an ink tank and the like are formed to complete an ink jet printer head.

### DISCLOSURE OF INVENTION

Along with the recent progress achieved in the area of personal computer, ink jet printers are becoming rapidly more popular. For further popularization of ink jet printers hereafter, it is necessary to reduce cost and achieve a higher resolution, and for this purpose, cost reduction and achievement of a higher resolution of ink jet printers are essential problems to be solved.

With the foregoing conventional art, however, it is necessary to provide a number of steps for the manufacture of a head base, and it is not easy to remarkably reduce the cost.

For achieving a higher resolution, furthermore, it is necessary to reduce the width and height of the ink pressure chamber and the width of a partition dividing the ink pressure chamber (represented by W, H and W′, respectively, in FIG. 12).

In the above-mentioned conventional art, however, the ink pressure chamber has substantially the same height as the thickness of a silicon wafer. In order to reduce the height of the ink pressure chamber, therefore, it is necessary to use a thinner silicon wafer. It is however the current practice to use wafers having a thickness of about 200 μm, and the use of a thinner wafer would cause difficulties in handling in the process flow, in view of the reduced strength resulting therefrom.

Further, in the aforesaid conventional art, the head base and the nozzle plate are integrally formed without using an adhesive. It is therefore difficult to prevent undesirable flow of the adhesive into the ink pressure chamber as a result of achievement of a higher resolution.

The present invention is therefore to solve these problems and has an object to provide a method of manufacturing an ink jet head which permits manufacture thereof through a simple process, to enable to cope with a higher resolution at a lower cost.

The method of manufacturing an ink jet printer head of the invention, comprises the step of ejecting an ink by pressurizing an ink pressure chamber by means of a piezo-electric element deforming in response to an electric signal, provided on a head base forming the ink pressure chamber; the manufacturing method of the head base comprises a first step of manufacturing a green sheet having a prescribed relief pattern in response to the head base; a second step of forming the head base by coating and solidifying a material for forming the head base on the surface of the green sheet having the relief pattern; a third step of stripping off the head base from the green sheet; and a fourth step of forming a nozzle port for discharging the ink on the head base. This feature of the invention permits manufacture of an ink jet printer head formed integrally with an ink ejecting nozzle, and gives an ink jet printer head capable of coping with a higher resolution at a lower cost.

In short, the present invention provides a method of forming a head base through copying of a green sheet. Once manufactured, the green sheet can be used repeatedly as long as the durability permits. The process can therefore be omitted in the manufacture of the second and subsequent head bases, thus making it possible to reduce the number of manufacturing steps and hence the cost.

Because the nozzle plate is formed integrally, a higher resolution can easily be achieved.

The first step can be accomplished, for example, as follows:

(1) Forming a resist layer in response to a prescribed pattern on the green sheet substrate, and then, forming the aforesaid relief pattern by etching on the green sheet substrate, thereby manufacturing the green sheet.

According to this step, it is possible to freely control at a high accuracy the shape of the relief pattern.

A silicon wafer is suitable as the green sheet substrate. The silicon wafer is etched by the technology for manufacturing a semiconductor device, which permits a highly accurate fabrication.

Quartz glass is also suitable as the green sheet substrate. Quartz glass is excellent in mechanical strength, heat resistance and chemicals resistance, and further, in transmissivity of a light of a short-wavelength region suitably applicable in means for improving strippability by irradiating a light to an interface between the green sheet and the head base.

(2) The second step of forming a resist layer in response to a prescribed pattern on the green sheet, then converting the second green sheet and the resist layer into conductors, electrically depositing a metal by the electroplating method to form a metal layer, and then stripping off the metal layer from the second green sheet and the resist layer, thereby manufacturing the green sheet.

The metal green sheet obtained in this step is excellent generally in durability and strippability.

The material for forming the head base should preferably be a substance hardenable by imparting an energy.

Since this substance can be handled in the form of a low-viscosity liquid when coating the same onto the green sheet, it is possible to fill even the slightest recesses on the green sheet with the head base forming material, thus permitting accurate copying of the relief pattern on the green sheet.

The energy should preferably be a light or heat or both a light and heat. Use of such an energy permits utilization of a general-purpose exposure unit, a baking oven or a hot plate, leading to a lower equipment cost and space saving.

The head base may be formed with a thermoplastic substance so far as the substance satisfies requirements for physical properties such as mechanical strength, corrosion resistance and heat resistance, and the slightest details of recesses on the original plate can easily be filled.

A suitable substance is, for example, hydrated glass.

A hydrated glass is a glass material exhibiting plasticity at low temperatures, and a head base excellent in mechanical strength, corrosion resistance and heat resistance is available by subjecting such a glass material to a dehydration treatment after forming.

In the third step, a particular combination of materials for the green sheet and the head base may result in a higher adhesion and may make it difficult to strip off the head base from the green sheet. In such a case, stripping from the green sheet can be satisfactorily accomplished by one or more of the following methods:

(3) Forming a recess of the relief pattern on the green sheet into a tapered shape so that the opening is larger than the bottom;

(4) Forming a stripping layer comprising a material having a low adhesion to the head base on the green sheet surface having the relief pattern; and

(5) Irradiating a light onto the interface between the green sheet and the head base.

In this case, the separating layer for causing stripping in the interior and/or at the interface with the green sheet through irradiation of a light may be provided between the green sheet and the head base. This increases the degree of freedom of choice of a material for forming the head base without causing any direct damage to the head base.

The fourth step may be accomplished as follows:

(6) Forming the ink discharging nozzle port by the lithographic method;

(7) Forming the ink discharging nozzle port by means of a laser beam;

(8) Forming the ink discharging nozzle port by means of a convergent ion beam; or

(9) Forming the ink discharging nozzle port through discharge fabrication.

Further, the present invention discloses an ink jet printer head manufactured by the steps as described above.

### BRIEF DESCRIPTION OF THE DRAWINGS

FIG. 1 illustrates a process of manufacturing a head base in an embodiment of the present invention;

FIG. 2 illustrates a process of manufacturing a green sheet in a first embodiment of the first step of the invention;

FIG. 3 illustrates a process of manufacturing an green sheet in a second embodiment of the first step of the invention;

FIG. 4 illustrates a process of manufacturing a green sheet in the second embodiment of the first step of the invention;

FIG. 5 illustrates a green sheet in an embodiment of the invention;

FIG. 6 illustrates a green sheet having a stripping layer formed thereon in an embodiment of the invention;

FIG. 7 illustrates a process of irradiating a light in an embodiment of the invention;

FIG. 8 illustrates a process of irradiating a light in an embodiment of the invention;

FIG. 9 illustrates a process of forming an ink discharging nozzle port in an embodiment of the invention;

FIG. 10 illustrates a process of forming a piezo-electric element on a head base in an embodiment of the invention;

FIG. 11 illustrates an example of the structure of an ink jet printer head; and

FIG. 12 illustrates an example of the conventional manufacturing process of an ink jet printer head.

10 green sheet

11 recess

12 headbase

13 ink discharging nozzle port

14 original plate substrate

15 resist layer

16 mask

17 light

18 exposure region

19 etchant

20 second original plate

21 mask

22 conductive layer

23 metal layer

24 stripping layer

25 irradiated light

26 decomposing layer

27 mask

28 third original plate

29 common electrode

30 piezo-electric thin film

31 upper electrode

32 piezo-electric element

33 ink pressure chamber

34 adhesive layer

35 nozzle plate

36 ink inlet

37 reservoir

38 ink tank inlet

39 silicon substrate (wafer)

40 thermal oxide film

### BEST MODE FOR CARRYING OUT THE INVENTION

Now, preferred embodiments of the invention will be described below with reference to the drawings.

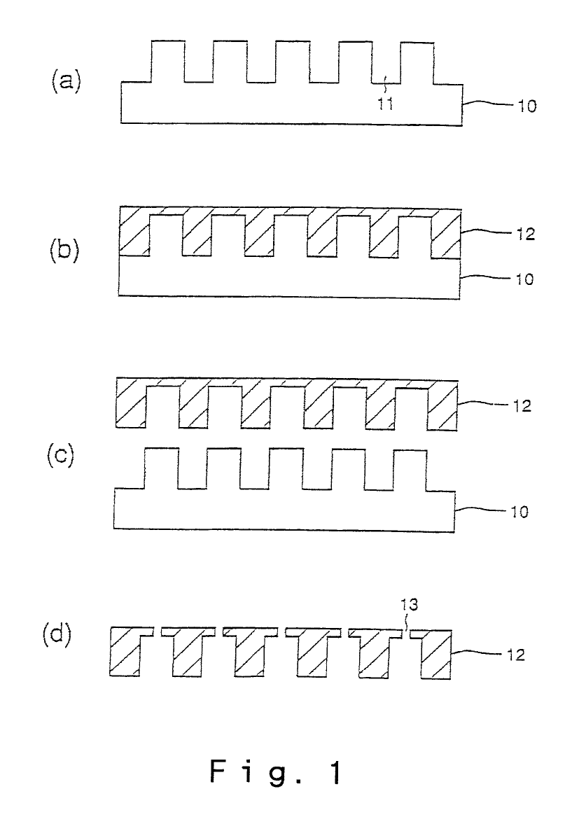

FIG. 1 illustrates a process of manufacturing a head base in an embodiment of the invention.

The method of manufacturing a head base of the invention comprises a first step of manufacturing a green sheet 10 having a relief pattern in response to the head base to be manufactured as shown in FIG. 1(a); a second step of forming a head base 12 by coating and solidifying a material for forming the head base onto the surface of the green sheet 10 having the relief pattern as shown in FIG. 1(b); a third step of stripping off the head base 12 from the green sheet 10 as shown in FIG. 1(c); and a fourth step of forming an ink discharging nozzle port on the head base 12 as shown in FIG. 1(d).

The individual steps will now be described below in detail.

(First Step)

This is a step of manufacturing the green sheet 10 having the relief pattern in response to the head base to be manufactured.

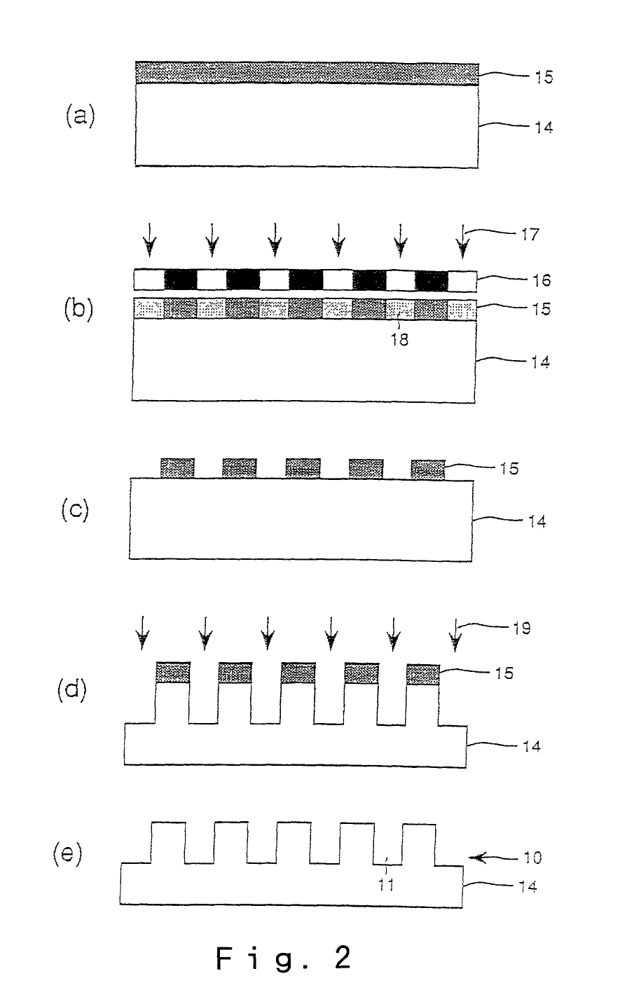

FIG. 2 illustrates a process of manufacturing a green sheet in the first embodiment of the first step.

The first step is more specifically carried out as follows:

First, a resist layer 15 is formed on a green sheet substrate 14 as shown in FIG. 2(a). The green sheet substrate 14 is a sheet to serve as a green sheet by etching the surface thereof, and a silicon wafer is used here. The technique for etching a silicon wafer has already been established in the manufacturing technology of a semiconductor device, and permits highly accurate etching. For the green sheet substrate 14, the material is not limited to a silicon wafer, but may be a substrate or a film of any of, for example, glass, quartz, a resin, a metal and ceramics.

A commercially available positive type resist prepared by blending a diazonaphthoquinone derivative as a photosensitive agent to the cresol novolak-based resin, commonly in use for the manufacture of a semiconductor device is applicable as it is as a material for forming a resist layer 15. The term the positive type resist as used here means a resist of which an exposed region can be selectively removed by a developing solution.

Forming of the resist layer can be accomplished by any of spin coating, dipping, spray coating, roll coating and bar coating.

Then, as shown in FIG. 2(b), a mask 16 is arranged on the resist layer 15, and an exposed region 18 is formed by irradiating a light 17 onto only a prescribed region of the resist layer 15 through the mask 16.

A pattern is formed on the mask 16 so that the light 17 transmits only through the region corresponding to the concave portions 11 shown in FIG. 2(e).

The concave portions 11 are formed in response to the shape and arrangement of the partitions forming the ink pressure chamber, the ink inlet and the reservoir of the ink jet head to be manufactured. After exposure of the resist layer 15, application of the developing treatment under prescribed conditions results in selective removal of the resist only at the exposed region 18 as shown in FIG. 2(c). The green sheet substrate 14 is thus exposed, and the other portions remain as covered with the resist layer 15.

Upon completion of patterning of the resist layer 15 as described above, the green sheet substrate 14 is etched to a prescribed depth with the resist layer 15 as a mask.

Etching is accomplished either in wet or in dry. Wet or dry etching is appropriately selected in response to particular specifications for properties such as material of the green sheet substrate, etching sectional shape and etching rate. In terms of controllability, dry etching is superior: it is possible to etch the concave portions into a desired shape including fabrication into a rectangle or tapering, by changing conditions such as etching gas seed, gas flow rate, gas pressure and bias voltage. Among others, the inductive coupling (ICP) method, the electron cyclotron resonance (ECR) method, and the high-density plasma etching method such as the helicon wave exciting method are suitable for deeply etching the green sheet substrate 14.

Then, after the completion of etching, the resist layer 15 is removed as shown in FIG. 2(e) to obtain the green sheet 10 having a relief pattern in match with the head base.

In the foregoing embodiment, the positive type resist has been used when forming the relief pattern on the green sheet substrate. A negative type resist may however be used, in which an exposed region is insoluble in the developing solution, and a non-exposed region can be selectively removed by the developing solution. In this case, a mask having a pattern reverse to that of the mask 16 is employed. Or, the resist may directly be patterned in exposure by means of a laser beam or an electron beam without the use of a mask.

Now, a second embodiment of the first step will be described below.

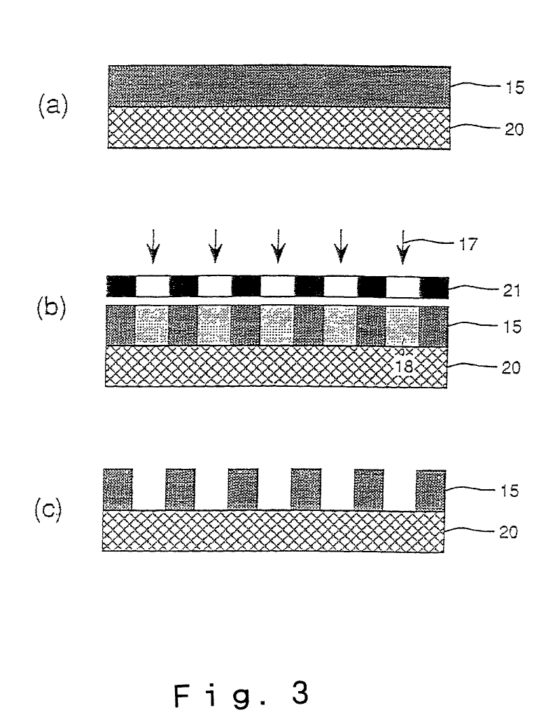

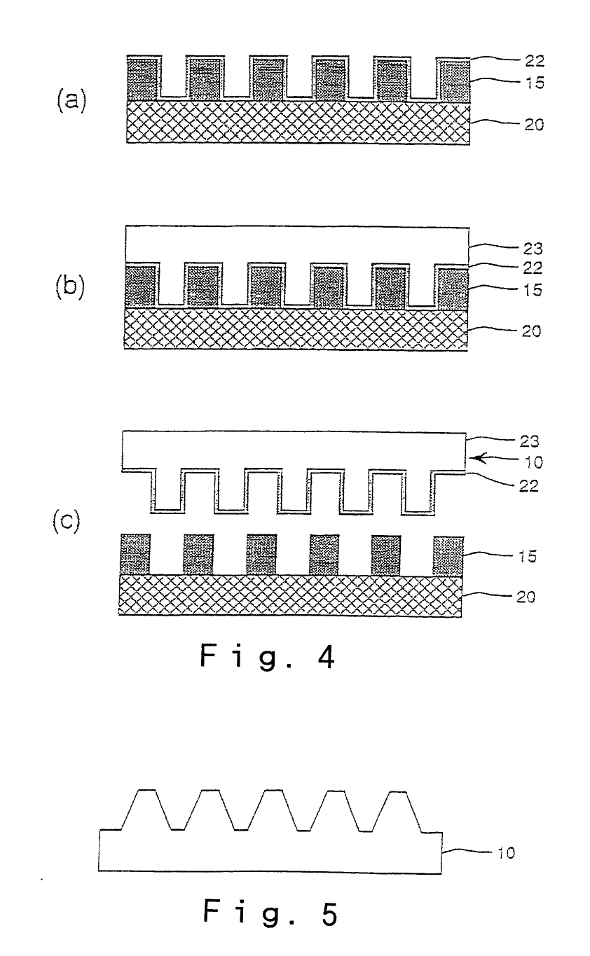

FIGS. 3 and 4 illustrate a process of manufacturing a green sheet in the second embodiment of the first step.

In the second embodiment, the first step is carried out as follows:

First, as shown in FIG. 3(a), a resist layer 15 is formed on the second green sheet 20.

The second green sheet 20 takes the role of a support for the resist layer 15 in the process flow. The material thereof is not particularly limited so far as a material has process resistance including a mechanical strength and chemicals resistance necessary for the process flow and is satisfactory in wettability and adhesion with the material forming the resist layer 15, including, for example, glass, quartz, a silicon wafer, a resin, a metal and ceramics substrates. A glass original plate prepared by polishing flat the surface of the material by the use of a cerium oxide-based abrasive, then washing and drying the same is used here.

The material and the method described as to the first embodiment mentioned above can be used for the resist layer 15 in the present embodiment, and therefore, description thereof is omitted.

Then, as shown in FIG. 3(b), a mask 21 is arranged on the resist layer 15, and a light 17 is irradiated onto only a prescribed region of the resist layer 15 through the mask 21, thereby forming an exposed region 18.

The mask 21 is patterned so that the light 17 transmits only through the region corresponding to the convex portions of the green sheet 10 to be manufactured, and has a pattern just reverse to that of the mask 16 shown in FIG. 2.

After exposure of the resist layer 15, application of a developing treatment under prescribed conditions permits selective removal of the resist of only the exposed region 18 as shown in FIG. 3(c), and the resist layer 15 is patterned.

Then, as shown in FIG. 4(a), a conductivity layer 22 is formed on the resist layer 15 and the second green sheet 20 to make the surface conductive.

As a conductivity layer 22, it suffices, for example, to form Ni into a thickness within a range of from 500 to 1,000 Å. The conductivity layer 22 can be formed by any of sputtering, CVD, vapor deposition and electroless plating.

Further, Ni is electrically deposited by the electroplating method using the resist layer 15 and the second green sheet 20 converted into conductors by the conductivity layer 22 as cathodes and an Ni chip or ball as an anode to form a metal layer 23 as shown in FIG. 4(b).

A typical composition of the electroplating solution is as follows:

| | |
|---|---|
| Nickel sulfamate | 500 g/l |
| Boric acid | 30 g/l |
| Nickel chloride | 5 g/l |
| Levelling agent | 15 mg/l |

Then, as shown in FIG. 4(c), the conductivity layer 22 and the metal layer 23 are stripped off from the second green sheet 20, and then the product is washed as required, to complete a green sheet 10.

The conductivity layer 22 may be removed from the metal layer 23 through a stripping treatment as required.

The second green sheet 20 can be reused by regeneration and washing as long as the durability thereof permits.

A negative type resist may used also in the foregoing second embodiment as in the first embodiment, and in this case, a mask having the same pattern as in the aforesaid mask 21, i.e., the mask 16 shown in FIG. 2 is used. Or, the resist may be directly exposed in a pattern shape to a laser beam or an electron beam without the use of a mask.

(Second Step)

This is a step of forming ahead case 12 by coating and solidifying a material for forming a head base on the surface of the green sheet 10 manufactured in the first step, having a relief pattern.

No particular limitation is imposed on the material for forming a head base, but various materials are applicable so far as the requirements for mechanical strength and properties such as corrosion resistance as a head base of an ink jet head are satisfied with a sufficient process durability. The material should preferably be hardenable by imparting an energy.

Since such a substance can be handled in the form of a low-viscosity liquid when coating the same onto the green sheet, it is possible to fill even the slightest details of concave portions on the green sheet with the head base forming material, thus permitting accurate copying of the relief pattern on the green sheet.

The energy should preferably be a light or heat or both a light and heat. Use of such an energy permits utilization of a general-purpose exposure unit, a baking oven or a hot plate, leading to a lower equipment cost and saving.

Applicable substances include, more specifically, acryl resins, epoxy resins, melamine resins, novolak resins, styrene resins, synthetic resins such as polyimide-based ones, and silicon-based polymers such as polysilazane.

Coating a head base forming material can be accomplished by any of spin coating, dipping, spray coating, roll coating and bar coating.

When the head base forming material contains a solvent component, a heat treatment should be applied to remove the solvent.

Then, a hardening treatment in match with the head base forming material is applied, and the material is solidified to form a head base 12.

A thermoplastic substance may be used as a head base forming material. Hydrated glass is suitable as such a substance. Hydrated glass contains water within a range of from several to several tens of wt. % and is in a solid state at the room temperature. It exhibits plasticity at low temperature (under 100° C., varying with the composition). Dehydration of such a hydrated glass after forming the head base gives a head base excellent in mechanical strength, corrosion resistance and heat resistance.

(Third Step)

This is a step of stripping off the head base 12 formed on the green sheet 10 in the second step from the green sheet 10.

More specifically, stripping step comprises fixing the green sheet 10 having the head base 12 formed thereon, attracting and holding the head base 12, and mechanically stripping it off.

Upon stripping, a particular combination of the materials for the green sheet and the head base 12 may lead to a higher adhesion, thus making it difficult to strip off the head base 12 from the green sheet 10.

In such a case, the concave portions of the relief pattern formed on the green sheet 10 should preferably have a tapered shape having a bottom larger than the opening. This allows to reduce stress such as a frictional force acting between the green sheet 10 and the head base 12 upon stripping, and hence ensure stripping from the green sheet 10.

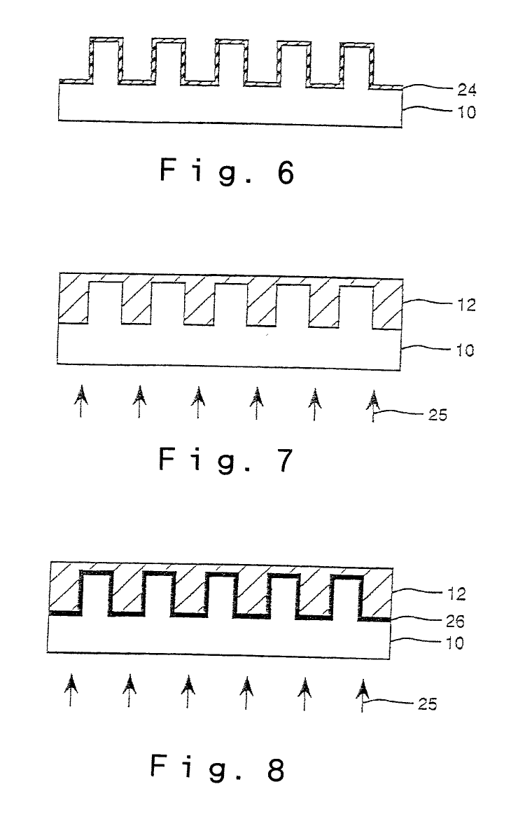

A similar effect is available also by forming a stripping layer 24 comprising a material having a low adhesion to the head base 12 on the surface of the green sheet 10 having a relief pattern, as shown in FIG. 6. It suffices to appropriately select a material for the stripping layer 24 in response to the materials for the green sheet 10 and the head base 12.

Stripping from the green sheet 10 may be made satisfactory by irradiating a light 25 onto the interface between the green sheet 10 and the head base 12 prior to stripping, as shown in FIG. 7 to reduce or eliminate adhesion between the green sheet and the head base 12. This is to reduce or eliminate various kinds of bonding force between atoms or molecules at the interface of the green sheet 10 and the head base 12, or in practice, to cause ablation or the like, which results in interfacial stripping, under the effect of the irradiated light.

Further, the irradiated light may in some cases cause release of gases from the head base 12, thereby permitting achievement of a separating effect. More specifically, the components contained in the head base 12 are evaporated and released to contribute to the separation.

The irradiated light 25 should preferably be an excimer laser. The excimer laser is practically applied in an apparatus providing a high energy output in the short wavelength region, and permits treatment in a very short period of time. Ablation is therefore caused only in the proximity of the interface, and hardly exerts a temperature impact onto the green sheet 10 or the head base 12.

The irradiated light 25 is not limited to the excimer laser, but any of various light beams (radiations) is applicable so far as it can cause interfacial stripping at the interface between the green sheet 10 and the head base 12.

It this case, it is necessary for the green sheet 10 to have transmissivity relative to the irradiated light 25. The transmissivity should preferably be at least 10%, or more preferably, at least 50%. With a transmissivity lower than this level, attenuation during transmission of the irradiated light trough the green sheet, resulting in a larger amount of light required for causing the aforesaid phenomenon such as ablation. Quartz glass, which has a high transmissivity and is excellent also in mechanical strength and heat resistance, is suitable as a material for the original plate.

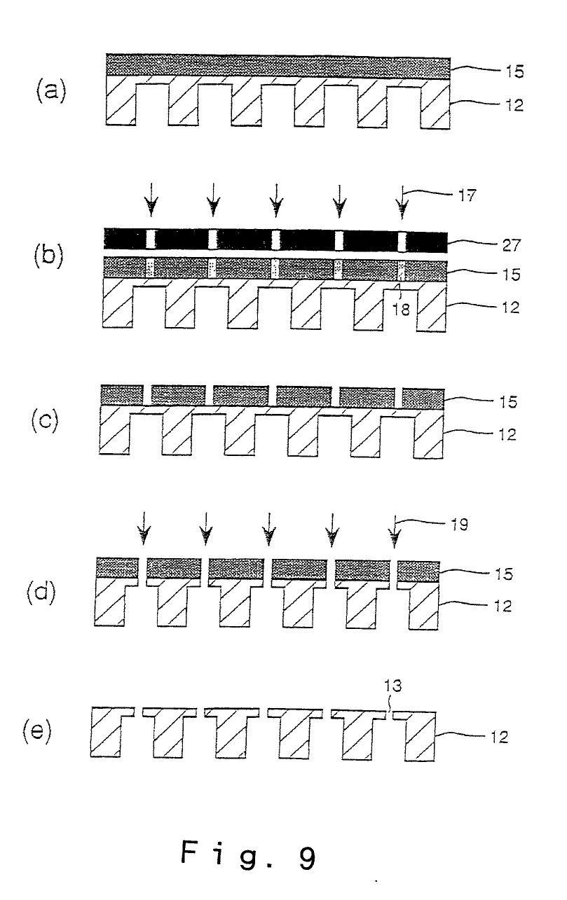

As shown in FIG. 8, a separating layer 26 for causing stripping at the interface with the green sheet 10 under the effect of the irradiated light 25 may be provided between the green sheet 10 and the head base 12. By causing ablation peeling in the separating layer 26 and/or at the interface, a direct impact is never exerted on the green sheet 10 or the head base 12.

Applicable materials for the separating layer 26 include non-crystalline silicon; various oxide ceramics such as silicon oxide, silicate compounds, titanium oxide, titanate compounds, zirconium oxide, zirconate compounds, lanthanum oxide and lanthanate compounds; (strong) dielectric bodies or semiconductors; nitride ceramics such as silicon nitride, aluminum nitride, and titanium nitride; organic polymer materials such as acrylic resins, epoxy resins, polyamide and polyimide; a metal or an alloy of two or more metals selected from the group consisting of Al, Li, Ti, Mn, In, Sn, Y, La, Ce, Nd, Pr, Gd, and Sm. One or more is appropriately selected from among the materials enumerated above in response to the process conditions and the materials for the green sheet and the head base 12.

No particular limitation is imposed on the forming method of the separating layer 26, but a method is appropriately selected in accordance with the composition and the thickness of the separating layer 26. More specifically, applicable methods for forming the separating layer 26 include various gas phase depositing method such as CVD, vapor deposition, sputtering, and ion plating, electroplating, Langmuir Blodgett (LB) method, spin coating, dipping, spray coating, roll coating and bar coating.

The thickness of the separating layer 26, varying with the object of stripping or the composition of the separating layer 26, should usually been within a range of from 1 nm to 20 μm, or more preferably, from 10 nm to 20 μm, or further more preferably, from 40 nm to 1 μm. A smaller thickness than this level of the separating layer 26 leads to a larger damage to the head base 12, and a larger thickness requires a larger amount of irradiated light for ensuring a good strippability of the separating layer 26. The thickness of the separating layer 26 should preferably be uniform as far as possible.

The residue of the separating layer 26 after stripping is removed through washing.

(Fourth Step)

This is a step of forming an ink discharging nozzle port 13 on the head base 12 obtained in the third step.

The method of forming the ink discharging nozzle port 13 is not limited to a particular one, but applicable methods include, for example, the lithographic method, laser fabrication, FIB fabrication and discharge fabrication.

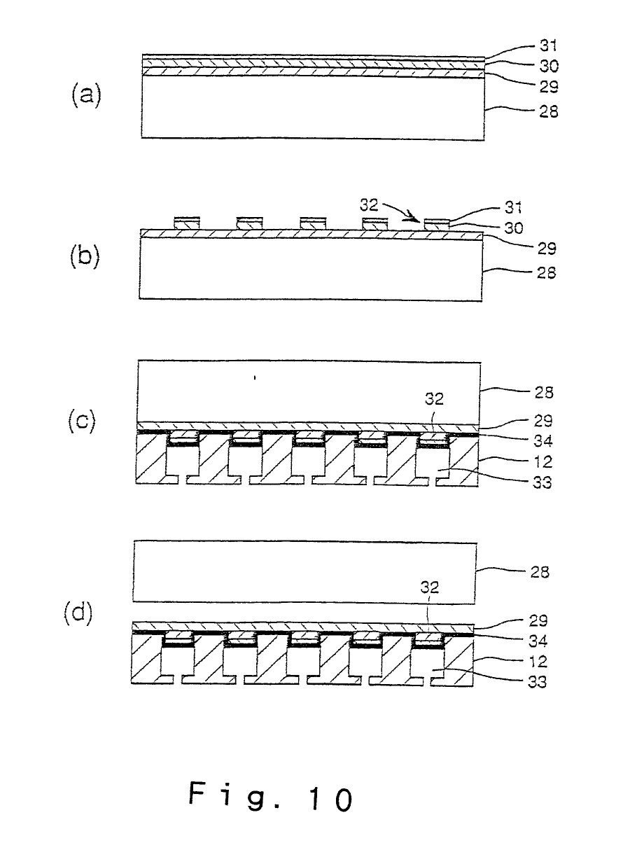

FIG. 9 illustrates a process of forming an ink discharging nozzle port 13 by the lithographic method. More specifically, the process is carried out as follows:

First, as shown in FIG. 9(a), a resist layer 15 is formed on the head case 12.

The material and the method of forming the resist layer 15 may be the same as those described above as to FIG. 2, and are not therefore described here.

Then, as shown in FIG. 9(b), a mask 27 is arranged on the resist layer 15, and a light 17 is irradiated only onto a prescribed region of the resist layer 15 through the mask 27, thereby forming an exposed region 18.

The mask 27 is pattern-formed so that the light 17 transmits only to a region corresponding to the ink discharging nozzle port 13 shown in FIG. 9(e).

The, after exposure of the resist layer 15, application of the developing treatment under prescribed conditions leads to selective removal of the resist of only the exposed region 18, as shown in FIG. 9(c) to expose the head base 12, and the other portions remain covered with the resist layer 15.

When the resist layer 15 is patterned as described above, etching is accomplished up to complete penetration through the head base 12 by using the resist layer 15 as a mask.

Etching may be conducted either in wet or in dry. Etching in wet or in dry is appropriately selected, depending upon the etching sectional shape, etching rate, and surface uniformity for the particular material for the ink jet base 12. In terms of controllability, the dry type is superior, and applicable dry methods include, for example, the parallel flat type reactive ion etching (RIE) method, the inductive coupling (ICP) method, the electron cyclotron resonance (ECR) method, the helicon wave exciting method, the magnetron method, the plasma etching method, and the ion beam etching method. The ink discharging nozzle port 13 can be etched to a desired shape including a rectangle and a tapered shape, by changing conditions such as the etching gas seed, gas flow rate, gas pressure, bias voltage and the like.

Then, after the completion of etching, as shown in FIG. 9(e), the head base 12 having an ink discharging nozzle port 13 formed therein obtained by removing the resist layer 15.

Lasers applicable for laser fabrication include various gas lasers and solid lasers (semiconductor lasers), and particularly, excimer lasers such as KrF, YAG laser, Ar laser, He—Cd laser and CO₂ laser are suitable. Among others, excimer laser is particularly suitable.

The excimer laser, providing a laser beam of a high energy output in the short wavelength region, permits fabrication in a very short period of time, thus resulting in a high productivity.

According to the lithographic method, it is possible to form ink discharging nozzle ports 13 at a plurality of positions at a time. However, this method leads to a high equipment cost and a higher materials cost, requiring a larger equipment space.

According to the method of manufacturing a head base as described above, the green sheet 10, once manufactured, can reused repeatedly as long as durability permits. The manufacturing steps of the second and subsequent semiconductors can therefore be omitted, thus permitting reduction of the number of processes and cost reduction.

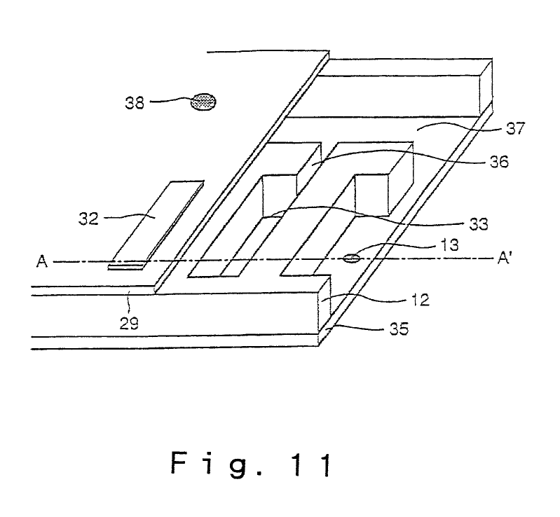

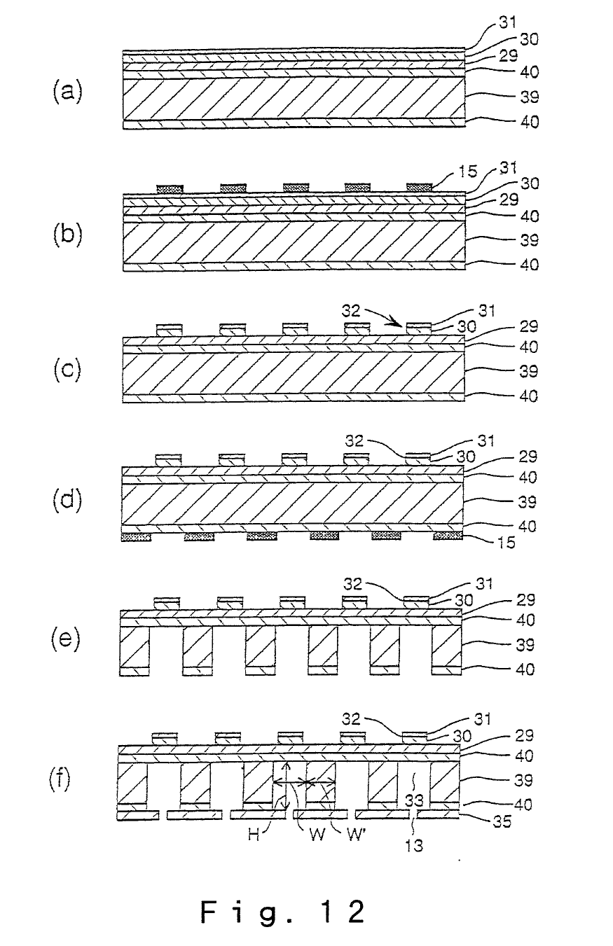

An example of the process of forming a piezo-electric element on the head base 12 formed in the aforesaid embodiment will now be described below with reference to FIG. 10. According to this process, the piezo-electric element is once formed on a third green sheet 28, and then copied onto the head base 12. More specifically, the process is carried out as follows:

First, as shown in FIG. 10(a), a common electrode 29, a piezo-electric thin film 30 and an upper electrode 31 are sequentially laminated on the third green sheet 28.

The third green sheet 28 plays a role as a support upon patterning the piezo-electric thin film 30 and the upper electrode 31 into elements, and should preferably have a process durability, particularly satisfactory heat resistance and mechanical strength. After bonding (adhesion) with the head base in a process following patterning of the piezo-electric thin film 30 and the upper electrode 31, stripping is conducted at the interface between the common electrode 29 and the third green sheet 28. Therefore, the third green sheet 28 should preferably not to be very high in adhesion with the common electrode 29.

The material for the common electrode 29 and the upper electrode 31 is not limited to a particular one so far as the electric conductivity is high. Applicable materials include, for example, Pt, Au, Al, Ni and In. It suffices to select appropriately a method of forming the common electrode 29 and the upper electrode 31 in response to the material and the film thickness. Applicable methods include, for example, sputtering, vapor deposition, CVD, electroplating and electroless plating.

As the material for the piezo-electric thin film for an ink jet printer, lead zirconate-titanate (PZT)-based substances are suitable. For forming a PZT-based substance into a film, the sol-gel method can appropriately be selected. A high-quality thin film is available by a simple process according to the sol-gel method.

A noncrystalline gel thin film is formed by repeating prescribed time a cycle comprising coating the common electrode 29 with a PZT-based substance having a composition adjusted to a prescribed one by spin coating, and temporarily baking the same. Further, the coated product is fully baked to obtain a piezo-electric thin film 30 having a perovskite crystal structure.

Apart from the sol-gel method, sputtering may be used for forming the piezo-electric thin film 30.

Then, as shown in FIG. 10(b), the piezo-electric thin film 30 and the upper electrode 31 are patterned into a piezo-electric element 32 in response to the pattern of the ink pressure chamber 33 of the head base 12 shown in FIG. 10(c).

Patterning can be carried out, for example, by the use of the lithographic method shown in FIG. 12. Description thereof is therefore omitted here.

Then, as shown in FIG. 10(c), the head base 12 obtained from the process shown in FIG. 1 is bonded, or stuck through an adhesive layer 34, to the third green sheet 28 having the common electrode 29 and the piezo-electric element 32 formed thereon.

The material for the adhesive layer 34 may be appropriately selected in match with the materials for the head base 12, the common electrode 29 and the piezo-electric element 32.

Then, as shown in FIG. 10(d), the head base 12, the common electrode 29 and the piezo-electric element 32 are integrally stripped off from the green sheet 28.

When the third green sheet 28 and the common electrode 29 are so highly adhesive to each other as to make it difficult to accomplish stripping, a light may be irradiated to promote stripping, as in the above description of the process shown in FIG. 7, and further, a separating layer may be provided as shown in FIG. 8.

Upon formation of the piezo-electric element 32 on the head base 12, a wiring pattern, a signal circuit, an ink tank and the like are incorporated to complete an ink jet printer head.

What is claimed is:

1. A method of manufacturing an ink jet printer head, comprising the step of ejecting an ink by pressurizing an ink pressure chamber by means of a piezo-electric element deforming in response to an electric signal, provided on a head base forming said ink pressure chamber; wherein:
a manufacturing method of said head base comprises a first step of manufacturing a green sheet having a prescribed relief pattern in response to said head base; a second step of forming said head base by coating and solidifying a material for forming said head base on the surface of said green sheet having said relief pattern; a third step of stripping off said head base from said green sheet; and a fourth step of forming a nozzle port for discharging the ink on said head base.

2. A method of manufacturing an ink jet printer head according to claim 1, wherein:
said first step comprises a step of forming a resist layer in response to a prescribed pattern on a substrate of green sheet, and then manufacturing said green sheet by forming said relief pattern on said substrate of green sheet by etching.

3. A method of manufacturing an ink jet printer head according to claim 2, wherein:
said substrate of green sheet is a silicon wafer.

4. A method of manufacturing an ink jet printer head according to claim 2, wherein:
said substrate of green sheet is made of quartz glass.

5. A method of manufacturing an ink jet printer head according to claim 1, wherein:
said first step comprises the steps of forming a resist layer in response to a prescribed pattern on a second green sheet, then converting said second green sheet and said resist layer into conductors, forming a metal layer by electrically depositing a metal by electroplating method, and then, stripping off said metal layer from said second green sheet and said resist layer to manufacture said green sheet.

6. A method of manufacturing an ink jet printer head according to claim 1, wherein:
the material for forming said head base is a substance hardenable by imparting energy.

7. A method of manufacturing an ink jet printer head according to claim 6, wherein:
said energy is a light or a heat, or both a light and a heat.

8. A method of manufacturing an ink jet printer head according to claim 1, wherein:
said head base is formed of a thermoplastic substance.

9. A method of manufacturing an ink jet printer head according to claim 8, wherein:
said thermoplastic substance is hydrated glass.

10. A method of manufacturing an ink jet printer head according to claim 1, wherein:
the recess of said relief pattern formed on said green sheet has a tapered shape having an opening larger than a bottom.

11. A method of manufacturing an ink jet printer head according to claim 1, wherein:
a stripping layer of a material having a low adhesion to said head base is formed on said green sheet surface having said relief pattern.

12. A method of manufacturing an ink jet printer head according to claim 1, wherein:
in said third step, said head base is stripped off from said green sheet by irradiating a light onto an interface between said green sheet and the head base.

13. A method of manufacturing an ink jet printer head according to claim 12, wherein:
said head base is stripped off from said green sheet in the interior of a separating layer and/or at an interface with said green sheet by providing said separating layer between said green sheet and said head base, and irradiating said light onto the interface between said green sheet and the separating layer.

14. A method of manufacturing an ink jet printer head according to claim 1, wherein:
said fourth step comprises forming said ink discharging nozzle port by the lithographic method.

15. A method of manufacturing an ink jet printer head according to claim 1, wherein:
said fourth step comprises forming said ink discharging nozzle port by means of a laser beam.

16. A method of manufacturing an ink jet printer head according to claim 1, wherein:
said fourth step comprises forming said ink discharging nozzle port by means of a converging ion beam.

17. A method of manufacturing an ink jet printer head according to claim 1, wherein:
said fourth step comprises forming said ink discharging nozzle port by discharge fabrication.

18. An ink jet printer head manufactured by the manufacturing method of an ink jet printer head according to any one of claims 1 to 17.
